(19) United States
(12) Patent Application Publication
(10) Pub. No.: US 2005/0111004 A1
(43) Pub. Date: May 26, 2005

(54) Specimen inspection apparatus and reference value setting unit and method of the specimen inspection apparatus

(76) Inventors: Byoung-Chul Kim, Gyeonggi-do (KR); Duck-Sun Yang, Gyeonggi-do (KR); Ho-Hyung Jung, Gyeonggi-do (KR); Young-Gil Kim, Gyeonggi-do (KR)

Correspondence Address: MARGER JOHNSON & McCOLLOM, P.C., 1030 S.W. Morrison Street, Portland, OR, 97205, US

(21) Appl. No.: 10/916,735

(22) Filed: Aug. 11, 2004

(30) Foreign Application Priority Data
Nov. 21, 2003 (KR) 2003-83179

(51) Int. Cl. G01N 21/47

(52) U.S. Cl. 356/446

(57) ABSTRACT

A reference value setting unit of a specimen inspection apparatus comprises a calibration specimen, a calibration light source for emitting a predetermined light to the calibration specimen, at least one detector for receiving a first light-scattering signal reflected through the calibration specimen as well as a second light-scattering signal reflected from an inspection specimen, and a detector calibration unit for comparing a measured value measured from the calibration specimen with a reference value for the detector, and for calculating an offset value for calibration based on the comparison to calibrate the detector.

### CROSS-REFERENCE TO RELATED APPLICATION

This application claims the benefit of Korean Patent Application No. 2003-83719, filed Nov. 21, 2003, the disclosure of which is hereby incorporated herein by reference in its entirety.

### BACKGROUND OF THE INVENTION

1. Field of the Invention

The present invention relates to a specimen inspection apparatus, and to a reference value setting unit and method of a specimen inspection apparatus.

2. Description of the Prior Art

Generally, a semiconductor device is formed by repeating the processes of stacking and patterning a plurality of material layers on a wafer. Here, when defects or contaminants which may happen at each material layer in the stacking or patterning process go beyond a predetermined allowable limit, the finished semiconductor device may not be operable or may malfunction. Therefore, currently, most semiconductor manufacturing processes include a wafer surface inspection process capable of, after each process, examining a wafer surface to check for defects or contamination with respect to the surface or interior of each formed material layer.

Currently, there are two wafer surface inspection methods: one makes use of laser scattering and the other makes use of a CCD (Charge Coupled Device). The inspection method using the laser scattering is designed to scan a laser on an object to be analyzed, for example on a wafer, to sense the scattered laser with a detector, and to analyze intensity of the sensed laser. This allows the number and size of particles existing on the wafer to be analyzed.

An inspection method using the laser scattering has been disclosed in Korean Patent Registration No. 10-0335491, titled “Wafer Inspection Apparatus Having Recipe Parameter Library and Method for Establishing Recipe Parameter In Wafer Inspection.” The patent relates to a wafer inspection apparatus for inspecting defects or contaminants of the surface of a wafer after completing certain predetermined processes. It also relates to a method for establishing recipe (or process) parameters of the inspection apparatus which are required to inspect the wafer. The patent is intended to reduce the time taken to establish the recipe parameters and to overcome the deviation due to the proficiency of the workers by pre-storing the recipe parameters of the inspection apparatus required to inspect the wafer, and using the parameters when the wafers experiencing the same process are inspected. A plurality of inspection apparatuses installed in the lines for manufacturing semiconductor devices as described above have reduced measuring errors by reestablishing the reference values periodically.

Japanese Patent Application Publication No. 2003-130809, titled “Device For Surface Inspection,” relates to a surface inspection system used in an inspection process and having a calibration wafer accommodation unit, in which a laser is emitted and received on a wafer, and the resulting data values are calibrated by a calibration program. After calibration, the wafer is transported by a transport system. This calibration operation is automatically performed.

FIGS. 1A to 1C show a process of setting a reference value in a conventional inspection apparatus using laser scattering in more detail. As shown in FIG. 1A, a predetermined number of standard particles 3, PSL (Poly Stylen Latex) particles, having a specific size and shape on a bare wafer 1 are spread using the PDS (Particle Deposition System) 4, and thereby a standard specimen 5 for calibration is prepared (S1).

Subsequently, as shown in FIG. 1B, after inputting the standard specimen 5 into the inspection apparatus, the number and size of the PSL particles on the standard specimen 5 are measured. It is checked whether the measured values are correct (S2).

Then, if the size of each PSL particle is wrongly measured in step S2, it proceeds to a calibration mode as shown in FIG. 1C and performs a calibration operation (S3). In this calibration operation, light scattered in the standard specimen 5 is sensed, and then intensity of the light is evaluated. Further, an operator selects and inputs at least two intensity values for the sizes of the PSL particles.

Then, as shown in the graph, errors of the measured values (hereinafter, referred to as “raw data”)(line B) inputted by the operator are calculated with regard to the reference values (line A) representing the intensity values for the sizes of the PSL particles, and a compensation operation for compensating the errors is performed (S3).

Thereafter, the above-mentioned processes are repeated again until the normal values for the calibration operation are obtained.

However, in the case of the conventional inspection mechanism based on the above-mentioned process, a first problem is that it requires additional cost to prepare the standard specimen for the calibration operation.

A second problem is that use of the bare wafer increases the consumption rate of wafer.

A third problem is that the PDS has to be used separately, and furthermore, if the PDS is lowered, it is difficult to rapidly cope with such a situation.

The forth problem is that, since the operator has to input manually the raw data values for the calibration operation, the data values may be wrongly inputted due to the mistake of the operator. In this case, since the error happens in the calibration operation, the calibration operation has to be performed again. This requires additional costs and time.

### SUMMARY OF THE INVENTION

Therefore, it is an objective of the present invention to solve the above mentioned problems and to provide a reference value setting unit of a specimen inspection apparatus, capable not only of attaching and using a calibration specimen within the specimen inspection apparatus, but also of evaluating a measured value of a detector which reads a light-scattering signal reflected through the calibration specimen and of calculating an error between the measured value of the detector and a reference value to calibrate the detector.

It is another objective of the present invention to provide a reference value setting method of a specimen inspection apparatus, capable of permanently attaching a calibration specimen within the specimen inspection apparatus, of evaluating a measured value of a detector which reads a light-scattering signal reflected through the calibration specimen, and of calculating an error between the measured value of the detector and a reference value to calibrate the detector.

In order to accomplish the objectives, according to a first aspect of the present invention, there is provided a reference value setting unit of a specimen inspection apparatus. The reference value setting unit comprises a calibration specimen, a calibration light source for emitting predetermined light to the calibration specimen, at least one detector for receiving a first light-scattering signal reflected through the calibration specimen as well as a second light-scattering signal reflected from an inspection specimen, and a detector calibration unit for comparing a measured value measured through the calibration specimen with a reference value for the detector, calculating an error value for calibration as a result of comparison to calibrate the detector.

Preferably, the detector calibration unit includes a reference value storage means for storing the reference value for the detector, a measured value storage means for storing the measured value measured through the calibration specimen, a comparator for comparing the measured value with the reference value and calculating the error value between the measured value and the reference value, and a processor for executing a correction command for the detector on the basis of the error value computed by the comparator.

Preferably, the calibration specimen is made of a material having good light-scattering property such as a ceramic material, and has one surface of a convex-concave profile.

Preferably, the reference value storage means stores a value of ideal intensity against a voltage applied to the detector, and the measured value storage means stores a value of really measured intensity against the voltage applied to the detector.

Further, the processor outputs the calibration command for a voltage value applied to the detector on the basis of the error value computed by the comparator According to a second aspect of the present invention, there is provided a specimen inspection apparatus which comprises a stage for seating an inspection specimen for inspection, a calibration specimen provided on one side of the stage, at least one light source for emitting predetermined light onto at least one of the calibration specimen and the inspection specimen, a detector for detecting a light-scattering signal reflected from the calibration specimen, and a detector calibration unit for comparing a measured value measured through the calibration specimen with a reference value for the detector and calculating a calibration value of the detector to calibrate the detector.

Preferably, the light source includes an inspection light source for emitting light toward the inspection specimen and a calibration light source for emitting light toward the calibration specimen. Further, the calibration light source emits the light having intensity lower than that of the inspection light source.

Preferably, the detector calibration unit includes a reference value storage means for storing the reference value for the detector, a measured value storage means for storing the measured value measured through the calibration specimen, a comparator for comparing the measured value with the reference value and calculating the error value between the measured value and the reference value, and a processor for executing a correction command for the detector on the basis of the error value computed by the comparator.

Preferably, the calibration specimen is installed on a location lower than that of a seated surface of the inspection specimen.

According to a third aspect of the present invention, there is provided a reference value setting method of a specimen inspection apparatus. The reference value setting method comprises the steps of emitting predetermined light toward a calibration specimen, sensing a light-scattering signal reflected from the calibration specimen by means of a detector, comparing a measured value sensed through the detector with a previously inputted reference value by means of a comparator, and calibrating the detector on the basis of a error value computed by the comparator.

Here, the comparator compares a value of ideal intensity against a voltage applied to the detector with a value of really measured intensity under a same condition for applying the voltage to the detector, and computes an error value between the values.

Further, the detector is calibrated by calibration of a voltage value applied to the detector on the basis of the error value computed by the comparator.

In addition, the calibration specimen is made of a material having good light-scattering property, and preferably a ceramic material, and has one surface of a convex-concave profile.

### BRIEF DESCRIPTIONS OF THE DRAWINGS

The preferred embodiments of the present invention will now be described by way of example with reference to the accompanying drawings in which:

FIGS. 1a to 1c show a reference value setting procedure of a conventional specimen inspection apparatus;

FIG. 2 shows a schematic configuration of a reference value setting unit of a specimen inspection apparatus according to one embodiment of the present invention;

FIG. 3 shows a schematic configuration of a specimen inspection apparatus to which an improved reference value setting unit is applied in accordance with another embodiment of the present invention; and

FIG. 4 shows a flow chart illustrating a reference value setting method of a specimen inspection apparatus according to still another of the present invention.

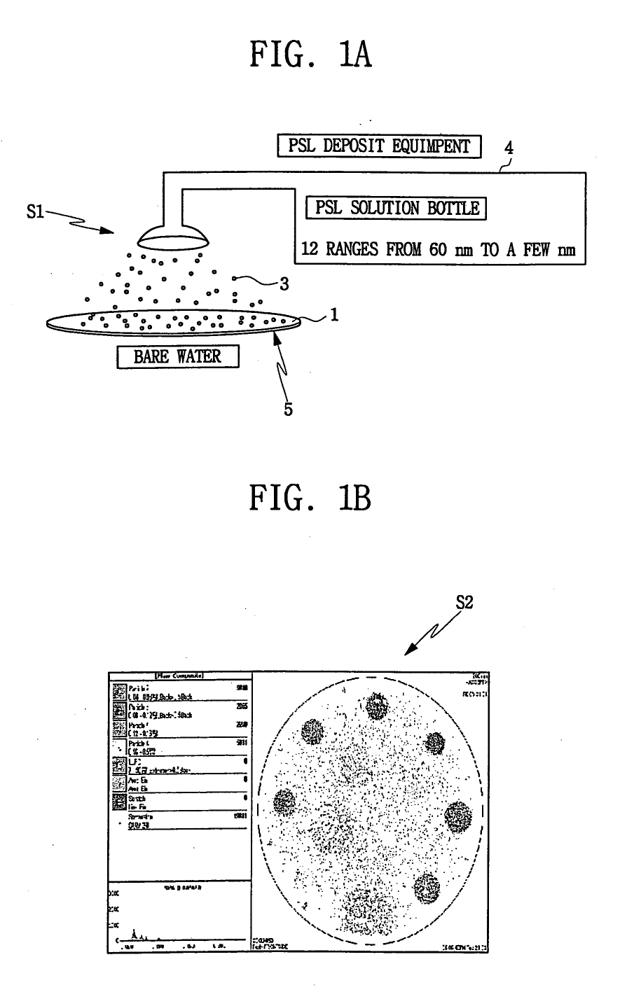

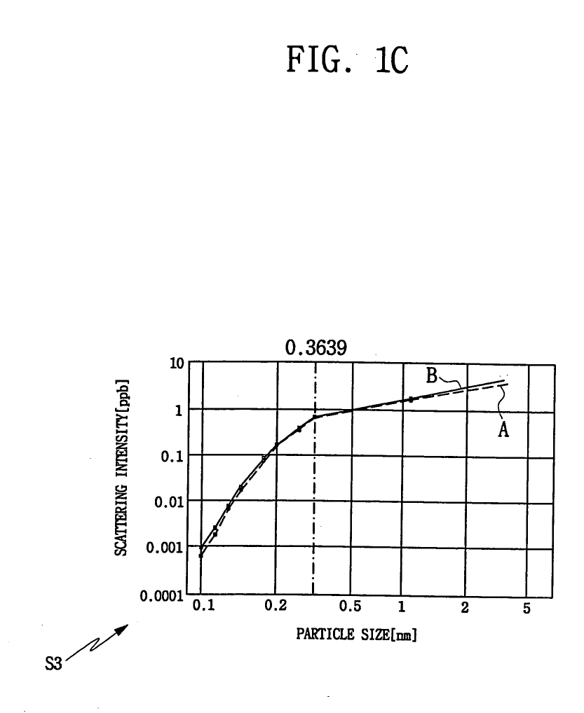

### DETAILED DESCRIPTION OF THE PREFERRED EMBODIMENT

The present invention will now be described more fully hereinafter with reference to the accompanying drawings, in which preferred embodiments of the invention are shown. This invention may, however, be embodied in different forms and should not be construed as limited to the embodiments set forth herein. Rather, these embodiments are provided so that this disclosure will be thorough and complete, and will fully convey the scope of the invention to those skilled in the art. In the drawings, the thickness of layers and regions are exaggerated for clarity. Like numbers refer to like elements throughout the specification.

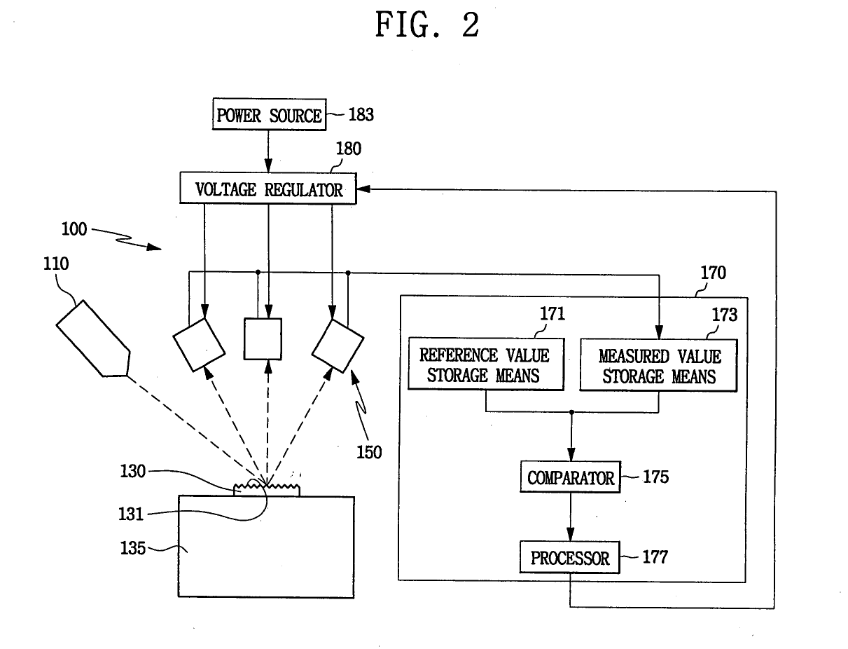

A reference value setting unit and method for a specimen inspection apparatus according to the present invention will hereinafter be described in more detail with reference to FIGS. 2 to 4.

FIG. 2 shows a schematic configuration of a reference value setting unit 100 of a specimen inspection apparatus according to one embodiment of the present invention. As shown in the figure, the reference value setting unit includes a calibration light source 110, a calibration specimen 130, at least one detector 150, and a detector calibration unit 170.

The calibration specimen 130 is installed on an upper surface of a fixed block 135 and is preferably made of a material having relatively high level of light-scattering properties, such as a ceramic material. It is preferable that the upper surface of the specimen be formed of a toothed configuration 131, more preferably it comprises a plurality of convex-concave elements, in order to facilitate the light-scattering properties of this invention.

The calibration light source 110 emits predetermined light toward the calibration specimen 130. For example, a preferred calibration light source 110 is a laser light source.

The detector 150 receives a light-scattering signal reflected by the calibration specimen 130 for measuring light-scattering intensity. The detector 150 preferably makes use of a photo-multiplier.

The detector calibration unit 170 includes a reference value storage unit 171 for storing reference a value from the detector 150, a measured value storage unit 173 for storing a value measured from the calibration specimen 130, a comparator 175 for comparing the reference value with the measured value and calculating an error value between these respective values, and a processor 177 for executing a calibration command for the detector 150 on the basis of the error value computed by the comparator 175.

Here, the reference value means a scattering intensity value measured against a voltage applied to the detector 150 under ideal conditions, and the measured value means a scattering intensity value which is actually measured against the same voltage based on the reference value. The comparator 175 computes the error value between the reference value and the measured value.

Meanwhile, on the basis of the error value, the processor 177 outputs a command to compel a calibration voltage to be applied to the detector 150 and to a voltage regulator 180 in order to compensate for the error value. Therefore, the processor 177 allows a voltage supplied from the power source 183 to be adjusted and outputted to the detector 150. When an inspection specimen (not shown) is inspected, the detector 150 receives the scattering intensity value of the light reflected from the inspection specimen.

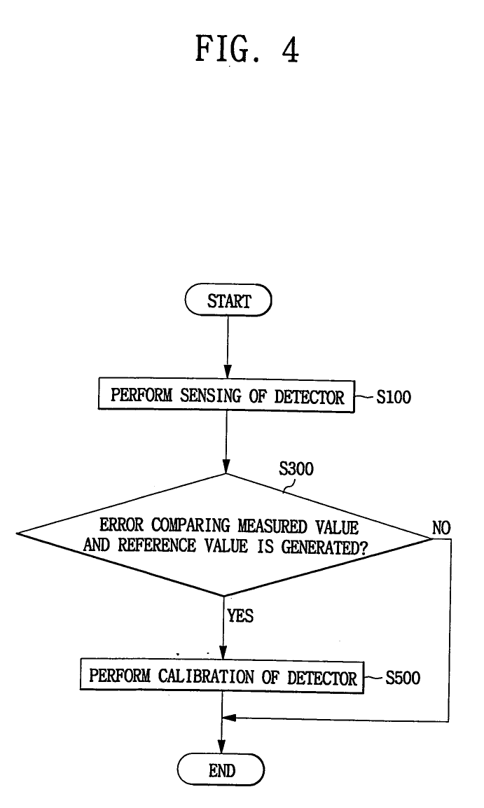

Next, a reference value setting method of a specimen inspection apparatus configured as set forth above will be described with reference to FIG. 4.

The calibration light source 110 emits a predetermined light toward the calibration specimen 130. Then, the detector 150 receives a light-scattering signal reflected from the calibration specimen 130, and measures intensity of the light-scattering signal. The measured value is stored in the measured value storage means 173 (S100). Meanwhile, the comparator 175 compares the measured value with a reference value previously inputed through the reference value storage means 171, thereby calculating an error value between the respective measured and reference values (S300).

When the offset value is computed as above, the processor 177 outputs a calibration command for calibration conditions of the detector 150 (S500). This calibration is intended to calibrate the offset value by changing the voltage value applied to the detector 150. In the case, where a signal for adjusting the supply voltage value supplied from the power source 183 is sent to the voltage regulator 180, the voltage regulator 180 outputs the adjusted voltage to the detector 150.

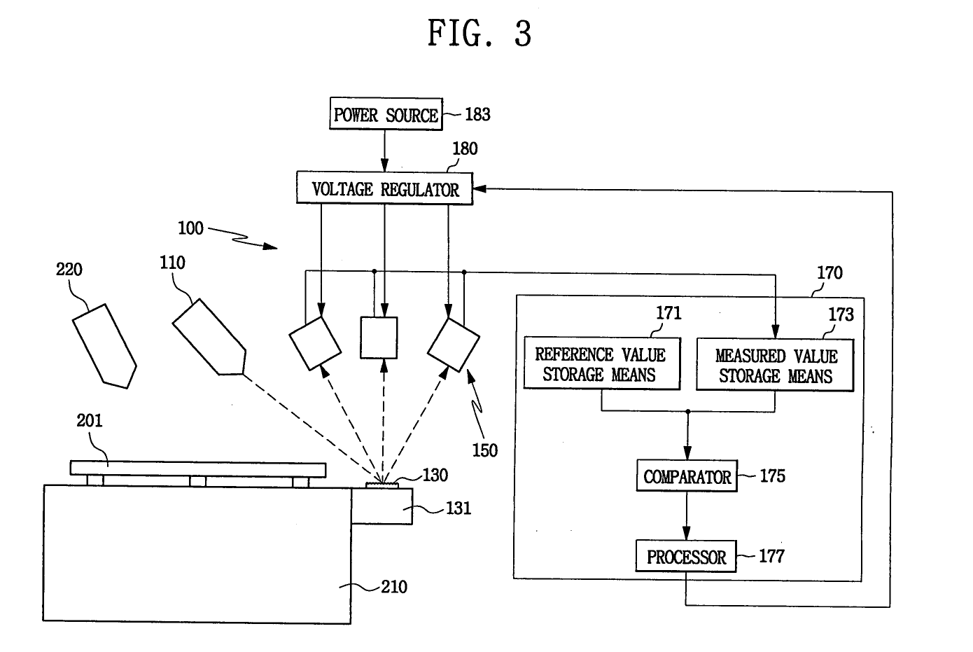

FIG. 3 shows one example in which the reference value setting unit 100 of FIG. 2 is applied to a specimen inspection apparatus for inspecting an inspection specimen. As shown, the calibration specimen 130 is installed on a stage 210 supporting the inspection specimen 201 (e.g., a wafer). At this time, it is preferable that the calibration specimen 130 is installed to be lower than a seated surface (bottom surface) of the inspection specimen 201 in order to remove interference to the inspection specimen 201.

Meanwhile, the calibration light source 110 emitting light toward the calibration specimen 130 is provided separately from an inspection light source 220 for inspecting the inspection specimen 201. It is operable if the inspection light source 220 itself is used as the calibration light source 110. However, it is preferable that any light source capable of meeting the condition that the intensity of light be low can be separately used for the calibration. In any case, it should be taken into consideration that the light outputted from the inspection light source 220 is high in intensity, and it will thus relatively accelerate the functional deterioration of the detector 150 as compared with that of the calibration light source 110.

In this case, when the calibration specimen 130 is installed on one side of the stage 210, it is preferable that the stage 210 is constructed to be installed to move horizontally, vertically or rotatably. Thus, for the calibration operation, the calibration specimen 130 is shifted to a predetermined location, while for the inspection operation of the inspection specimen 201, the inspection specimen 201 is shifted to the predetermined location.

As can be seen from the foregoing, with regard to setting the reference value of the inspection apparatus, in the case where the value sensed by the detector is analyzed to have a difference with respect to the reference value, the error value is compensated for by the detector, so that the cost for the calibration can be remarkably reduced together with the time used for calibration. This leads to an advantage of the invention.

While the invention has been disclosed in its preferred form, the specific embodiments thereof as disclosed and illustrated herein are not to be considered in a limiting sense. Indeed, it should be readily apparent to those skilled in the art in view that various changes in form and details may be made therein without departing from the spirit and scope of the invention as defined by the appended claims and their equivalents.

1. A reference value setting unit of a specimen inspection apparatus comprising:
a calibration specimen;
a calibration light source for emitting a predetermined light to the calibration specimen;
at least one detector for receiving a first light-scattering signal reflected from the calibration specimen and a second light-scattering signal reflected from an inspection specimen; and
a detector calibration unit for comparing a measured value from the calibration specimen with a reference value for the detector, and for calculating an offset value for calibration based on said comparison for calibrating the detector.

2. The reference value setting unit as claimed in claim 1, wherein the detector calibration unit further includes a reference value storage unit for storing the reference value for the detector, a measured value storage unit for storing the measured value from the calibration specimen, a comparator for comparing the measured value with the reference value and for calculating the offset value between the measured value and the reference value, and a processor for executing a correction command for the detector based on the offset value computed by the comparator.

3. The reference value setting unit as claimed in claim 1, wherein the calibration specimen is made of a material which has relatively high level of light-scattering properties.

4. The reference value setting unit as claimed in claim 3, wherein the material of the calibration specimen is a ceramic material.

5. The reference value setting unit as claimed in claim 1, wherein the calibration specimen has at least one surface having a convex-concave profile.

6. The reference value setting unit as claimed in claim 2, wherein the reference value storage unit stores a value of ideal intensity measured against a voltage applied to the detector, and the measured value storage unit stores a value of actually measured intensity measured against the voltage applied to the detector.

7. The reference value setting unit as claimed in claim 2, wherein the processor outputs a calibration command for a voltage value applied to the detector on the basis of the error value computed by the comparator.

8. A specimen inspection apparatus comprising:
a stage for supporting an inspection specimen for inspection;
a calibration specimen provided on the stage;
at least one light source for emitting a predetermined light onto at least one of the calibration specimen and the inspection specimen;
a detector for detecting a light-scattering signal reflected from the calibration specimen; and
a detector calibration unit for comparing a measured value from the calibration specimen with a reference value for the detector, and for calculating a calibration value for the detector.

9. The specimen inspection apparatus as claimed in claim 8, wherein the light source includes an inspection light source for emitting light toward the inspection specimen and a calibration light source for emitting light toward the calibration specimen.

10. The specimen inspection apparatus as claimed in claim 9, wherein the calibration light source can emit a light having an intensity lower than the intensity of the inspection light source.

11. The specimen inspection apparatus as claimed in claim 8, wherein the detector calibration unit includes a reference value storage unit for storing the reference value for the detector, a measured value storage unit for storing the measured value from the calibration specimen, a comparator for comparing the measured value with the reference value and for calculating the offset value between the measured value and the reference value, and a processor for executing a correction command for the detector on the basis of the error value computed by the comparator.

12. The specimen inspection apparatus as claimed in claim 8, wherein the calibration specimen is made of a material which has relatively high level of light-scattering properties.

13. The specimen inspection apparatus as claimed in claim 12, wherein the material of the calibration specimen is a ceramic material.

14. The specimen inspection apparatus as claimed in claim 8, wherein the calibration specimen has at least one surface having a convex-concave profile.

15. The specimen inspection apparatus as claimed in claim 11, wherein the reference value storage unit stores a value of ideal intensity measured against a voltage applied to the detector, and the measured value storage unit stores a value of actually measured intensity measured against the voltage applied to the detector.

16. The specimen inspection apparatus as claimed in claim 8, wherein the calibration specimen is installed at a location lower than that of a seated surface of the inspection specimen.

17. A method for setting a reference value of a specimen inspection apparatus comprising:
providng a calibration specimen;
emitting a predetermined light to the calibration specimen;
reflecting a light-scattering signal from the calibration specimen;
sensing the light-scattering signal with a detector;
comparing a sensed measured value sensed of the light-scattering signal with reference value with a comparator; and
calibrating the detector based on an error value computed using the comparator.

18. The method as claimed in claim 17, wherein the comparator compares a value of ideal intensity measured against a voltage applied to the detector with a value of actually measured intensity under the same conditions for applying the voltage to the detector, and computes an error value between the compared values.

19. The method as claimed in claim 17, wherein the detector is calibrated by calibrating a voltage value applied to the detector on the basis of the error value computed by the comparator.

20. The method as claimed in claim 17, wherein the calibration specimen is made of a material having a relatively high level of light-scattering property.

21. The method as claimed in claim 20, wherein the calibration specimen is a ceramic material.

22. The reference value setting method as claimed in claim 17, wherein the calibration specimen has at least one surface having a convex-concave profile.
